(19) United States
(12) Patent Application Publication
(10) Pub. No.: US 2008/0244668 A1
(43) Pub. Date: Oct. 2, 2008

(54) SYSTEM AND APPARATUS FOR SEARCHING MEDIA STATIONS

(75) Inventor: Scott White, Austin, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/692,724

(22) Filed: Mar. 28, 2007

(51) Int. Cl. H04N 7/173

(52) U.S. Cl. 725/100

(57) ABSTRACT

A system and apparatus for searching media stations is disclosed. A system that incorporates teachings of the present disclosure may include, for example, a set-top box having a video processor that presents multimedia programs at a media device, and a controller element that manages operations of the video processor and searches for a broadcast channel associated with a media station according to a search string corresponding to one among a name of the media station, and call letters of the media station. Additional embodiments are disclosed.

### FIELD OF THE DISCLOSURE

The present disclosure relates generally to search techniques, and more specifically to a system and apparatus for searching media stations.

### BACKGROUND

Today there are many media broadcast networks competing for consumer attention. Consequently, distributors of media services now provide their subscribers a large supply of broadcast channels. Satellite and cable television for instance can provide hundreds of channels to choose from. Often the channels consumers prefer are dispersed in the lineup of total channels available. Moreover, the number of preferred channels is often too many to readily memorize.

Because of the increased selection, consumers rely on several methods to find preferred channels. For example, some users page through an electronic programming guide to find a preferred channel. Others resort to a printed channel card with call letters or station names to find a channel number of interest. These methods although viable can be frustrating to consumers.

A need therefore arises for a system and apparatus for searching media stations.

### BRIEF DESCRIPTION OF THE DRAWINGS

FIG. 1 depicts an exemplary embodiment of a communications system;

FIG. 2 depicts an exemplary method operating in the communications system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and apparatus for searching media stations.

In a first embodiment of the present disclosure, a set-top box (STB) can have a video processor that presents multimedia programs at a media device, wherein said multimedia programs are supplied to the video processor by way of a communications system, and a controller element that manages operations of the video processor and searches for a broadcast channel associated with a media station according to a search string corresponding to one among a name of the media station, and call letters of the media station.

In a second embodiment of the present disclosure, a computer-readable storage medium can have computer instructions for identifying a broadcast channel responsive to a search conducted with a search string comprising one among a name of a media station, and call letters of the media station.

In a third embodiment of the present disclosure, a multimedia system can have a controller element that receives a request to search for a broadcast channel according to a search string comprising one among a name of the media station, and call letters of the media station.

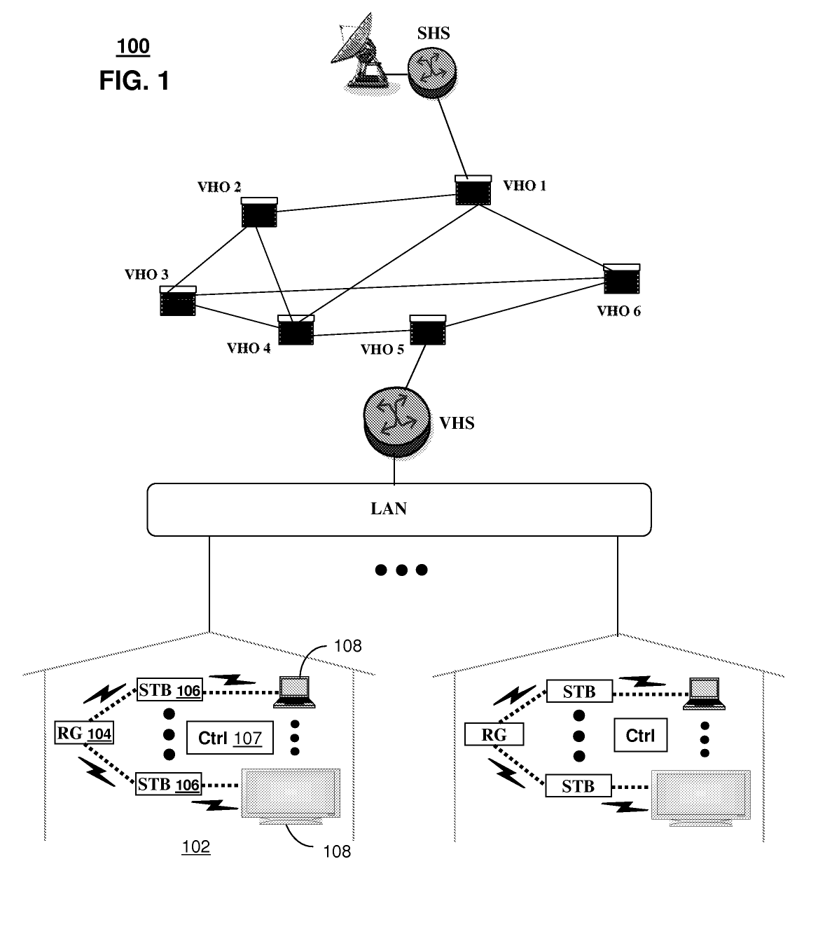

FIG. 1 depicts an exemplary embodiment of a communication system 100. The communication system 100 can comprise a multimedia system such as an IPTV communications system that can be configured to provide iTV services. For illustration purposes only, communication system 100 will be referred to as iTV system 100. In a typical IPTV backbone, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 102 housing a gateway 104 (e.g., a residential gateway or RG) that distributes broadcast signals to receivers such as Set-Top Boxes (STBs) 106 which in turn presents by way of a common video processor broadcast selections on display units or media devices 108 such as computers or television units managed in some instances by a media controller 107 (e.g., an infrared or RF remote control). Unicast traffic can also be exchanged between the STBs 106 and the subsystems of the IPTV communication system for presenting iTV services.

Although not shown, the aforementioned IPTV system can also be combined with analog broadcast distributions systems. Accordingly, an iTV system 100 can comprise in whole or in part any of the aforementioned IPTV subsystems, cable TV subsystems, and/or satellite TV subsystems. Said subsystems can be centralized or decentralized computing devices operating within iTV system 100. Additionally these subsystems can comprise a mass storage system and a controller element. The mass storage system can utilize common storage technologies (e.g., hard disk drives, flash memory, etc.), while the controller element can utilize common computing resources (e.g., a microprocessor, desktop computer, server, etc.) to present and manage interactive user interfaces (UIs) on the media device 108.

It should be noted that in the present context, media programs can mean audio media, still image media, and/or moving image media such as radio/stereo, CD quality audio, TV programming, game videos, album management of still pictures, and so on.

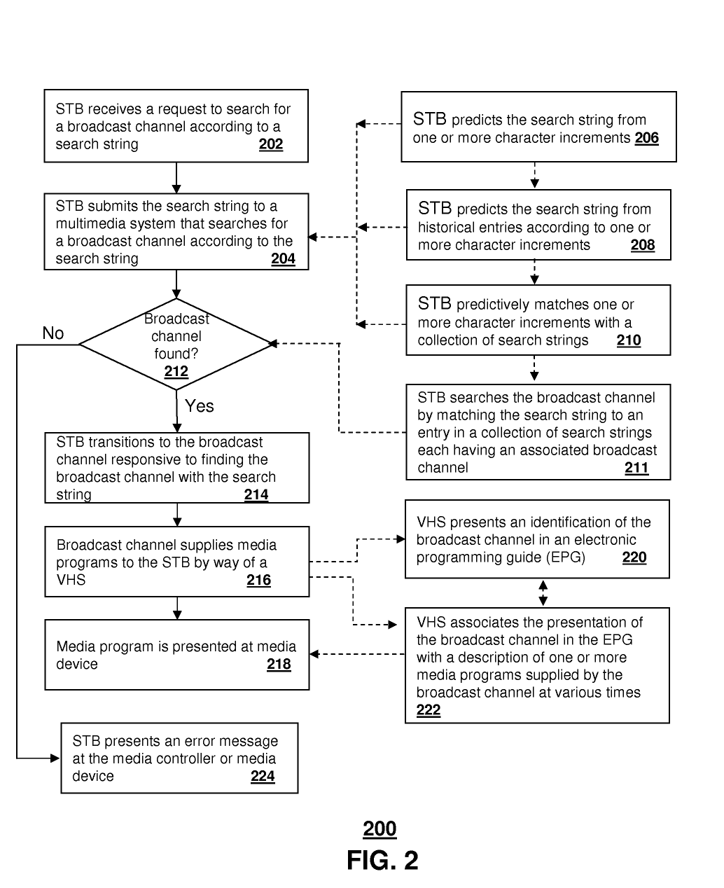

FIG. 2 depicts an exemplary method 200 operating in portions of the iTV system 100. Method 200 can begin with step 202 in which the STB 106 receives a search string to locate a broadcast channel. The search string request can be supplied by a media controller 107 or a navigation interface (e.g., keypad) of the STB 106 or the media device 108. For example, the search string request can be initiated by selecting a physical or soft button on the media controller 107 (e.g., FBN meaning “find by name”). Using an alphanumeric keypad of the media controller 107 (such as a Qwerty keyboard) a user can enter a search string associated with a media station. The search string can correspond to a name of the media station (e.g., Nickelodeon, Disney, Oxygen, C-SPAN, etc.) or call letters of the media station (e.g., WNKR, WGBA, etc.) as opposed to a channel number.

At step 204, the STB 106 can submit the search string to an iTV subsystem (e.g., VHS) which in turn searches for the corresponding broadcast channel according to the search string. The search string can serve as an index into a database of the VHS to identify the corresponding broadcast channel. The database can be organized by media names and/or call letters. Each database entry with a media name or call letter can have a corresponding broadcast channel number. Upon successfully finding the broadcast channel with the search string, the VHS provides the broadcast channel number to the STB 106.

In a supplemental embodiment, the STB 106 can be programmed to predict the search string while progressively receiving the search string in step 206 as one or more character increments. For example, the media controller 107, having alphabetic and numeric buttons, can provide one of more entered characters of the search string to the STB 106, in response to a user input. Using common predictive text techniques (similar to those used by cell phones), the STB 106 can present at the media controller 107 or the media device 108 a prediction of what the desired string might be. If the prediction is correct, the end user can then select the predicted text by common means via the media controller 107 (e.g., depressing an OK button or some other key stroke that indicates to the STB an acceptance of the predicted string). If the prediction is not yet correct, the end user can continue entering more characters until the prediction is correct, or the search string is completely entered. This embodiment provides the end user with a means to save key strokes, and thereby improve the end user's efficiency and user experience for submitting a request to identify a broadcast channel associated with the search string.

In another arrangement, the STB 106 can predict in step 208 the search string from historical entries collected by the STB from the end user as well as other users of the STB. In this embodiment, the STB 106 can search through a database of historical entries and predict the search string by attempting to find a match as each character increment is received. This technique can be similar to a technique used by browsers that store historical search entries. In yet another arrangement, the STB 106 can predict in step 210 the search string by matching one or more character increments with one among a collection of search strings supplied by for example the VHS. Once the search string is determined by any one of the embodiments of steps 206-210, and accepted by the end user supplying the search string, the STB 106 proceeds to step 204 as previously described.

In yet another arrangement, the STB 106 can be programmed with a database of search strings and associated broadcast channels to perform its own searches for the broadcast channel without assistance from the VHS or some other subsystem of the iTV system 100. In this embodiment, the STB 106 can identify in step 211 the broadcast channel by matching the search string and an entry in its database. This embodiment can be helpful in reducing packet traffic between the VHS and the STBs in multiple buildings 102 served by the VHS.

From steps 202-211, the STB 106 can proceed to step 212 where it determines if the search for a broadcast channel was successful. If a broadcast channel is found matching the search string, the STB 106 can proceed to step 214 where it transitions to the broadcast channel. In steps 216, the broadcast channel supplies media programs to the STB 106 which are in turn presented in step 218 at the media device 108. Alternatively in step 220 the VHS can present at the STB 106 an identification of the broadcast channel in an electronic programming guide (EPG). In step 222 the VHS can also present in the EPG a description of one or more media programs supplied by the broadcast channel at various times.

Referring back to step 212, if the search string cannot be associated with a broadcast channel, the STB 106 can proceed to step 224 where it presents an error message at the media controller 107 or the media device 108. The error message can indicate to the user that search string is not recognized. Alternatively or in combination, the error message can provide suggested alternates in the event the end user inadvertently entered an incorrect string.

Upon reviewing the aforementioned embodiments, it would be evident to an artisan with ordinary skill in the art that said embodiments can be modified, reduced, or enhanced without departing from the scope and spirit of the claims described below. For example, each time a search string request is entered it can be stored in memory for creating a history of search requests. Additionally, the embodiments of method 200 can be preformed in whole or in part by the SHS, VHO, the media controller 107, the media device 108, or a computing system coupled to the iTV system 100 functioning in whole or in part as a search engine for media name, or call letters. For example, method 200 can be performed in a media controller 107 that can store broadcast channels and associated media name or call letter strings. In this embodiment, the media controller 107 can store in its memory the media names and/or call letters of all broadcast channels supplied to the STB 106.

These are but a few examples of modifications that can be applied to the present disclosure without departing from the scope of the claims stated below. Accordingly, the reader is directed to the claims section for a fuller understanding of the breadth and scope of the present disclosure.

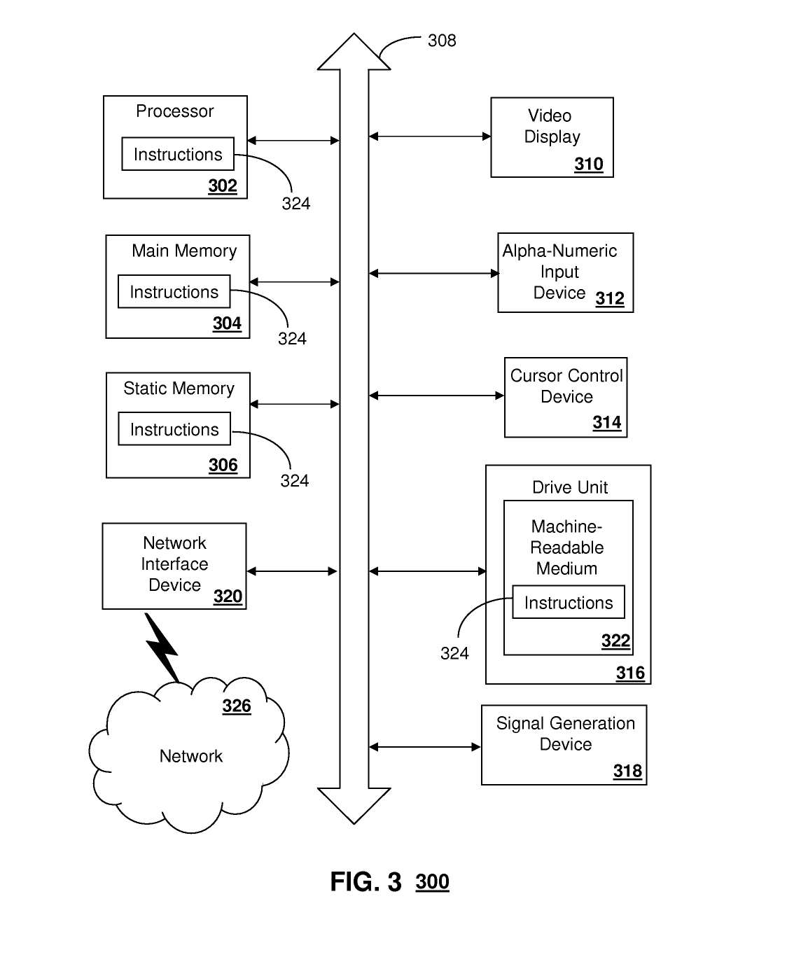

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A set-top box (STB), comprising:
a video processor that presents multimedia programs at a media device, wherein said multimedia programs are supplied to the video processor by way of a communications system; and
a controller element that manages operations of the video processor and searches for a broadcast channel associated with a media station according to a search string corresponding to one among a name of the media station, and call letters of the media station.

2. The STB of claim 1, wherein the controller element receives the search string from a media controller that manages in part operations of the STB.

3. The STB of claim 1, wherein the controller element:
transitions to the broadcast channel responsive to finding said broadcast channel with the search string; and
presents at a media device a media program supplied by said broadcast channel.

4. The STB of claim 3, wherein the controller element finds in a memory of the STB the broadcast channel according to the search string.

5. The STB of claim 3, wherein the controller element:
submits the search string to a multimedia system that searches for the broadcast channel according to said search string; and
receives the broadcast channel from the multimedia system.

6. The STB of claim 1, wherein the controller element:
receives the search string in one or more character increments; and
predicts the search string from said one or more character increments.

7. The STB of claim 6, wherein the controller element predicts the search string from historical entries according to the one or more character increments.

8. The STB of claim 6, wherein the controller element predicts the search string by predictively matching the one or more character increments with one among a collection of search strings.

9. The STB of claim 1, wherein the broadcast channel supplies media programs to the STB by way of a multimedia system, wherein the media programs comprise at least one among audio media, still image media, and moving image media, wherein the multimedia system comprises at least one among Internet Protocol Television (IPTV) subsystem, a cable TV subsystem, and a Set-Top Box (STB) operating with one among the IPTV and cable TV subsystems.

10. A computer-readable storage medium, comprising computer instructions for identifying a broadcast channel responsive to a search conducted with a search string comprising one among a name of a media station, and call letters of the media station.

11. The storage medium of claim 10, comprising computer instructions for:
transitioning to the broadcast channel responsive to finding said broadcast channel with the search string; and
presenting at a media device a media program supplied by said broadcast channel.

12. The storage medium of claim 10, comprising computer instructions for:
submitting the search string to a multimedia system that searches for the broadcast channel according to said search string; and
receiving the broadcast channel from the multimedia system.

13. The storage medium of claim 10, comprising computer instructions for:
receiving the search string in one or more character increments; and
predicting the search string from said one or more character increments.

14. The storage medium of claim 13, comprising computer instructions for predicting the search string from a collection of historical entries according to the one or more character increments.

15. The storage medium of claim 13, comprising computer instructions for predicting the search string by predictively matching the one or more character increments with one among a collection of search strings.

16. The storage medium of claim 10, comprising computer instructions for presenting an identification of the broadcast channel in an electronic programming guide (EPG).

17. The storage medium of claim 16, comprising computer instructions for associating the presentation of the broadcast channel in the EPG with a description of one or more media programs supplied by the broadcast channel at various times.

18. A multimedia system, comprising a controller element that receives a request to search for a broadcast channel according to a search string comprising one among a name of the media station, and call letters of the media station.

19. The multimedia system of claim 16, wherein the controller element:
receives the search string from a set-top box (STB); and
identifies the broadcast channel according to a match between the search string and one among a collection of search strings each having an associated broadcast channel.

20. The multimedia system of claim 19, comprising computer instructions for transmitting an identification of the broadcast channel to the STB.
